(19) United States
(12) Patent Application Publication
(10) Pub. No.: US 2017/0083491 A1
(43) Pub. Date: Mar. 23, 2017

(54) EMOJI SEMANTIC VERIFICATION AND RECOVERY

(71) Applicant: INTERNATIONAL BUSINESS MACHINES CORPORATION, Armonk, NY (US)

(72) Inventors: DAVID KUMHYR, AUSTIN, TX (US); SU LIU, AUSTIN, TX (US); CHENG XU, BEIJING (CN); QUAN WEN ZHANG, BEIJING (CN)

(21) Appl. No.: 14/858,048

(22) Filed: Sep. 18, 2015

(51) Int. Cl. G06F 17/24; G06F 3/0484; G06F 17/27; G06F 17/28; G06F 3/0481; G06F 17/21

(52) U.S. Cl. CPC G06F 17/24; G06F 3/04817; G06F 17/214; G06F 17/2785; G06F 17/2735; G06F 17/276; G06F 17/2872; G06F 3/04842

(57) ABSTRACT

A method and system are provided for assisting a user with Emoji in communication content. The system includes a user interface for receiving an input string that includes one or more Emoji characters for interpretation based on a user profile. The system further includes a processor-based Emoji semantic verification and recovery system for verifying and recovering an intended meaning of the one or more Emoji characters in the input string, by applying rules based on the user profile and natural language processing to analyze the input string for semantic context, interpret the one or more Emoji characters based on the semantic context, and replace at least one of the one or more Emoji characters with one or more other characters to form a modified input string.

### BACKGROUND

Technical Field

The present invention relates generally to Emoji and, in particular, to Emoji semantic verification and recovery.

Description of the Related Art

Emoji has been widely used by 6 billion mobile users in the world. In the United State, for example, more than eighty percent of short messages include at least one Emoji character. On Twitter, more than 89.77% users are using Emoji.

Emoji is a useful language, however there are some problems and issues in using Emoji. For example, many people cannot fully understand meanings of all listed Emoji characters. Also, a lot of studies show that people cannot use Emoji characters without assistants. For example, there are more than 800 Emoji characters defined in Unicode, but of 81.79% of Emoji messages only 23 Emoji characters have been used therein. Additionally, Emoji is still a new language for many users and, thus, it is not easy to choose the right Emoji to send to others as well as being hard to understand Emoji characters received from others. Moreover, there are risks to misusing and misunderstanding messages, which include too many Emoji characters crossing social media network due to different Emoji meanings under different circumstances.

Therefore, it is necessary to define a method of Emoji semantic verification and recovery for helping people to learn and use Emoji character under changing mobile communication environments.

### SUMMARY

According to an aspect of the present principles, a method is provided for assisting a user with Emoji in communication content. The method includes receiving, by a user interface, an input string that includes one or more Emoji characters for interpretation based on a user profile. The method further includes verifying and recovering, by a processor-based Emoji semantic verification and recovery system, an intended meaning of the one or more Emoji characters in the input string, by applying rules based on the user profile and natural language processing to analyze the input string for semantic context, interpret the one or more Emoji characters based on the semantic context, and replace at least one of the one or more Emoji characters with one or more other characters to form a modified input string.

According to another aspect of the present principles, a computer program product is provided for assisting a user with Emoji in communication content. The computer program product includes a non-transitory computer readable storage medium having program instructions embodied therewith. The program instructions are executable by a computer to cause the computer to perform a method. The method includes receiving, by a user interface, an input string that includes one or more Emoji characters for interpretation based on a user profile. The method further includes verifying and recovering, by a processor-based Emoji semantic verification and recovery system, an intended meaning of the one or more Emoji characters in the input string, by applying rules based on the user profile and natural language processing to analyze the input string for semantic context, interpret the one or more Emoji characters based on the semantic context, and replace at least one of the one or more Emoji characters with one or more other characters to form a modified input string.

According to yet another aspect of the present principles, a system is provided for assisting a user with Emoji in communication content. The system includes a user interface for receiving an input string that includes one or more Emoji characters for interpretation based on a user profile. The system further includes a processor-based Emoji semantic verification and recovery system for verifying and recovering an intended meaning of the one or more Emoji characters in the input string, by applying rules based on the user profile and natural language processing to analyze the input string for semantic context, interpret the one or more Emoji characters based on the semantic context, and replace at least one of the one or more Emoji characters with one or more other characters to form a modified input string.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary processing system 100 to which the present principles may be applied, in accordance with an embodiment of the present principles;

FIG. 2 shows an exemplary system 200 for Emoji semantic verification and recovery, in accordance with an embodiment of the present principles;

FIGS. 3-7 shows an exemplary method 300 for Emoji semantic verification and recovery, in accordance with an embodiment of the present principles;

FIG. 8 shows an exemplary cloud computing node 810, in accordance with an embodiment of the present principles;

FIG. 9 shows an exemplary cloud computing environment 950, in accordance with an embodiment of the present principles; and

FIG. 10 shows exemplary abstraction model layers, in accordance with an embodiment of the present principles.

### DETAILED DESCRIPTION OF PREFERRED EMBODIMENTS

The present principles are directed to Emoji semantic verification and recovery.

The present principles advantageously provide a method and system for Emoji semantic verification and restoration that helps people to properly choose and understand Emoji characters in modern communication. In an embodiment, a framework is constructed with multiple Emoji semantic analysis elements for verifying and recovering Emoji meanings behind each Emoji mixed textural string, and restoring Emoji mixed strings to normal plain textural strings based on, for example, preference settings. The preference settings can be set by, for example, a service provider and/or a user.

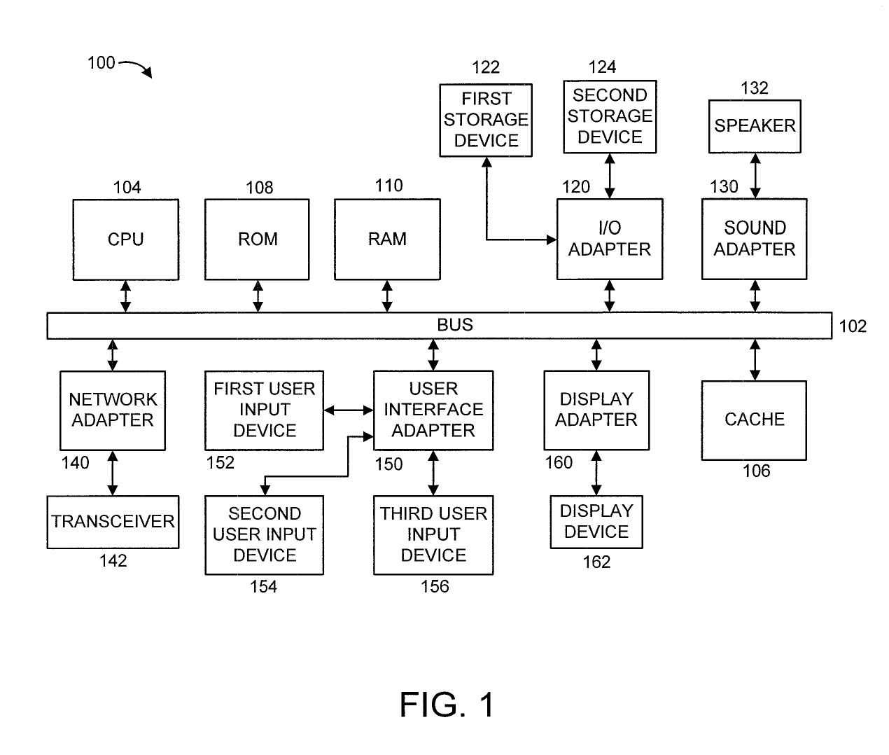

FIG. 1 shows an exemplary processing system 100 to which the present principles may be applied, in accordance with an embodiment of the present principles. The processing system 100 includes at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, are operatively coupled to the system bus 102.

A first storage device 122 and a second storage device 124 are operatively coupled to system bus 102 by the I/O adapter 120. The storage devices 122 and 124 can be any of a disk storage device (e.g., a magnetic or optical disk storage device), a solid state magnetic device, and so forth. The storage devices 122 and 124 can be the same type of storage device or different types of storage devices.

A speaker 132 is operatively coupled to system bus 102 by the sound adapter 130. A transceiver 142 is operatively coupled to system bus 102 by network adapter 140. A display device 162 is operatively coupled to system bus 102 by display adapter 160.

A first user input device 152, a second user input device 154, and a third user input device 156 are operatively coupled to system bus 102 by user interface adapter 150. The user input devices 152, 154, and 156 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present principles. The user input devices 152, 154, and 156 can be the same type of user input device or different types of user input devices. The user input devices 152, 154, and 156 are used to input and output information to and from system 100.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present principles provided herein.

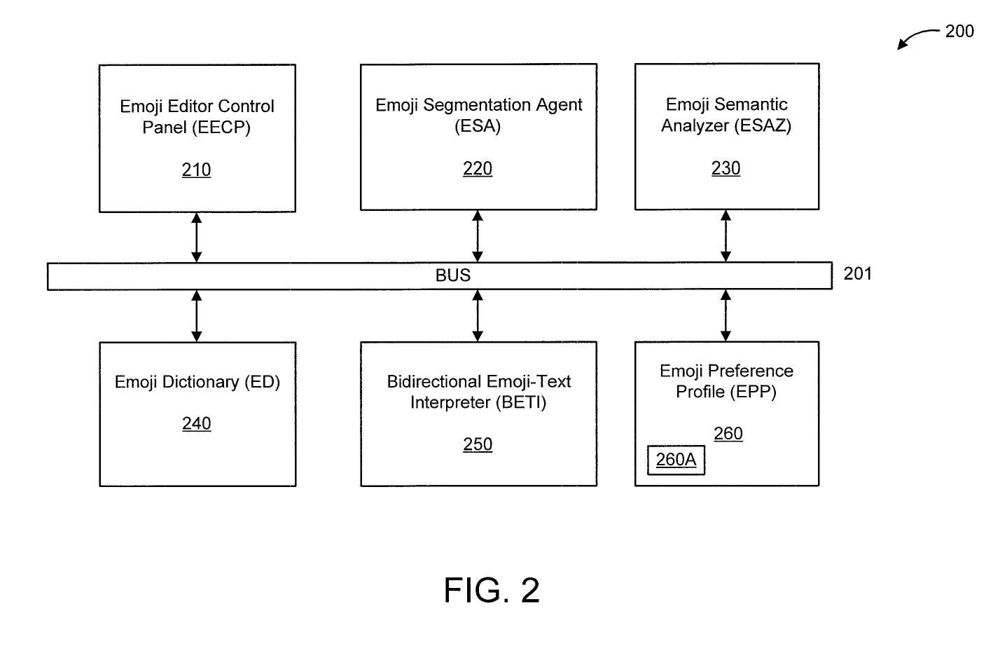

Moreover, it is to be appreciated that system 200 described below with respect to FIG. 2 is a system for implementing respective embodiments of the present principles. Part or all of processing system 100 may be implemented in one or more of the elements of system 200.

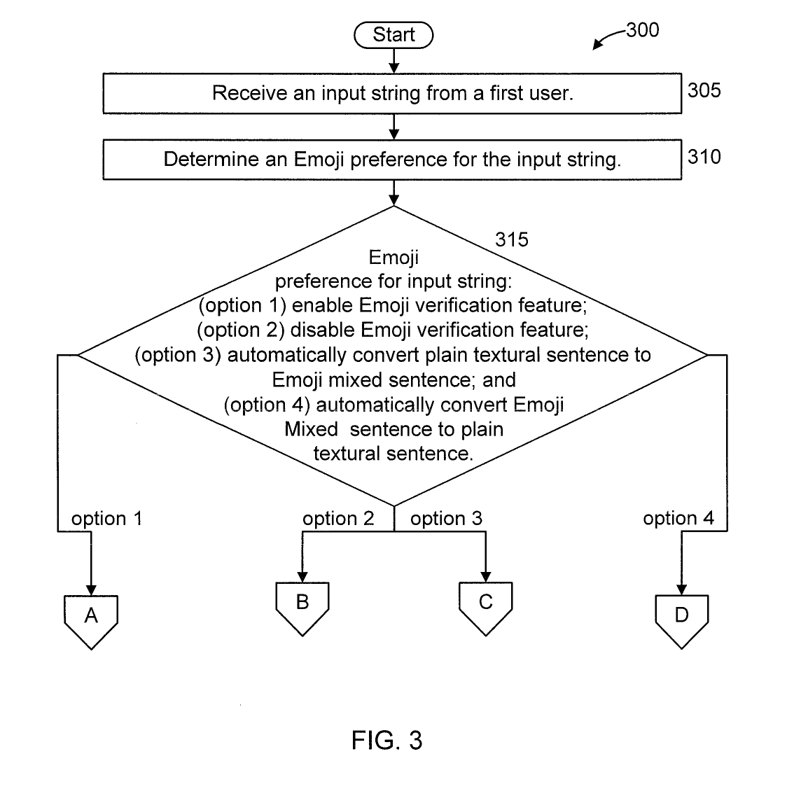

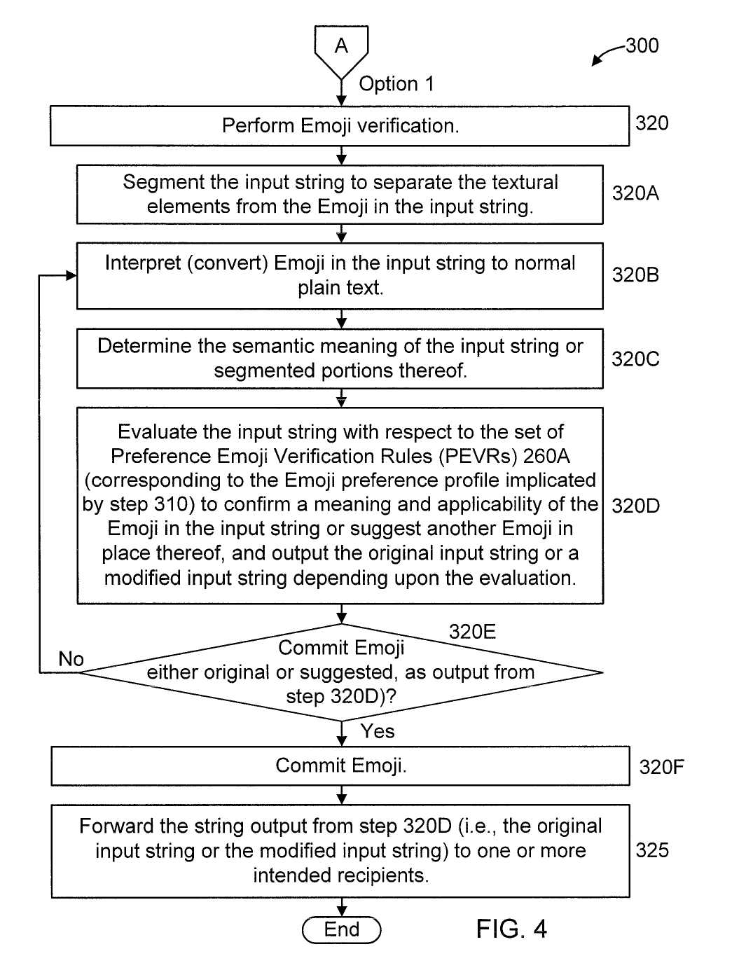

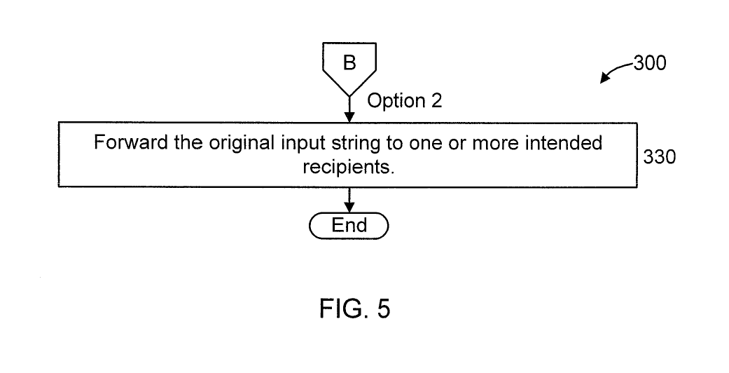

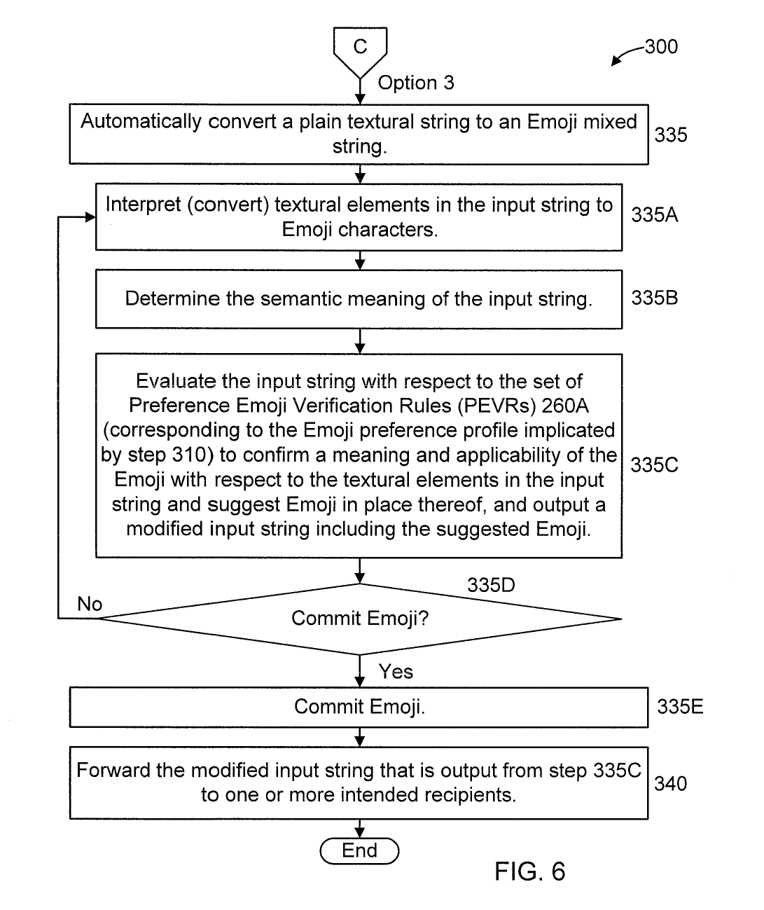

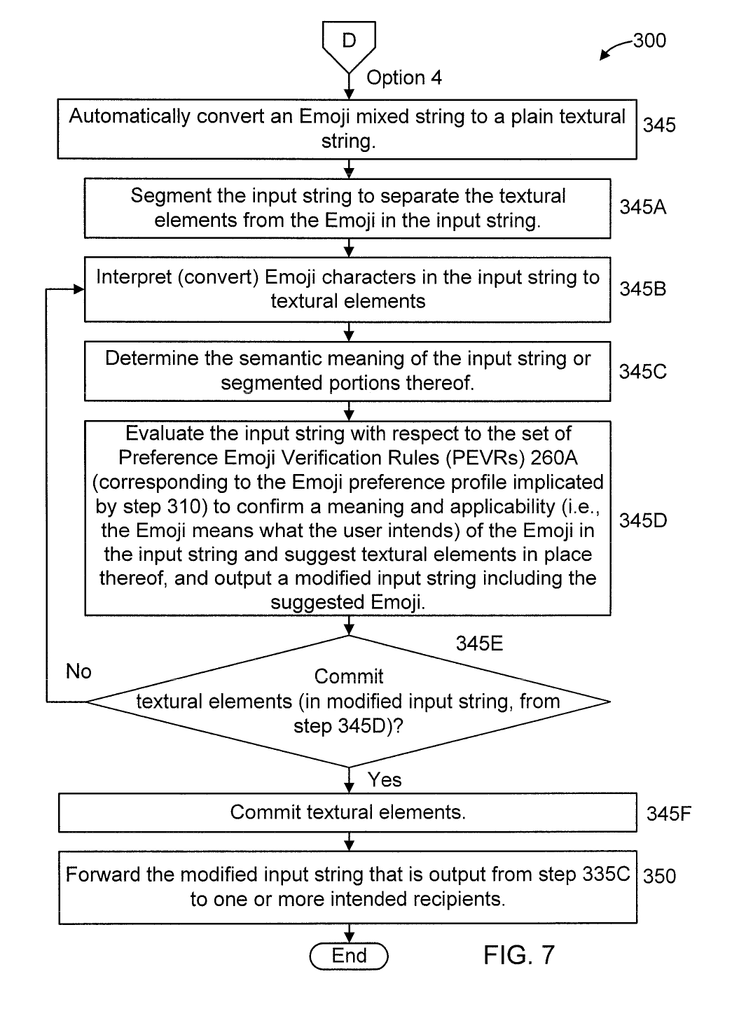

Further, it is to be appreciated that processing system 100 may perform at least part of the method described herein including, for example, at least part of method 300 of FIGS. 3-7. Similarly, part or all of system 200 may be used to perform at least part of method 300 of FIGS. 3-7.

FIG. 2 shows an exemplary system 200 for Emoji semantic verification and recovery, in accordance with an embodiment of the present principles.

The system includes an Emoji Editor Control Panel (EECP) 210, an Emoji Segmentation Agent (ESA) 220, an Emoji Semantic Analyzer (ESAZ) 230, an Emoji Dictionary (ED) 240, a Bidirectional Emoji-Text Interpreter (BETI) 250, and an Emoji Preference Profile (EPP) 260.

The Emoji Editor Control Panel (EECP) 210 is a user interface that allows a user to verify and restore Emoji phrases.

The Emoji Segmentation Agent (ESA) 220 is a program to segment Emoji phrases.

The Emoji Semantic Analyzer (ESAZ) 230 analyzes inputted Emoji and obtains the semantic meaning of the inputted Emoji based on context.

The Emoji Dictionary (ED) 240 includes Emoji meaning collections/dictionaries for different categories and languages (ED1, ED2, ED3, . . . , EDn).

The Bidirectional Emoji-Text Interpreter (BETI) 250 is a program to interpret messages from Emoji mixed textural to normal plain text and/or vice versa.

The Emoji Preference Profile (EPP) 260 is a set of predefined Emoji preference rules provided by, e.g., vendors or/and users. Exemplary preference rules include, but are not limited to: (1) enable the Emoji verification feature; (2) disable the Emoji verification feature; (3) automatically convert a plain textural sentence to an Emoji mixed sentence; and (4) automatically interpret (convert) an Emoji mixed sentence to a plain textural sentence.

The Emoji Preference Profile (EPP) 260 includes set of Preference Emoji Verification Rules (PEVRs) 260A defined by service providers and/or users. Based the on those PEVRs 260A, users are assisted in verifying Emoji meanings of Emoji strings and, if warranted, restore the Emoji strings in real time.

The Preference Emoji Verification Rules (PEVRs) 260A are a set of rules for helping users to verify and the Emoji meaning on context before commit it into a message in chat session. For instance, both Emoji CACTUS U+1F335 and Emoji TACO U+1F32E could be used to present Mexican styles or flavors. PEVR defines a preference rule as following: FOOD (CACTUS U+1F335, TACO U+1F32E)=TACO U+1F32E, because TACO U+1F32E is better than CACTUS U+1F335 for presenting Mexican food.

In an embodiment, the system 200 can be considered to include a natural language processor. While shown as part of system 200, in another embodiment, the Emoji Editor Control Panel (EECP) 210 can be a separate element with respect to system 200, but nonetheless interfaces with system 200.

In an embodiment, use of the system 200 can be controlled/invoked relative to a service. For example, users can sign up for a service that employs Emoji semantic verification and recovery. In an embodiment, the service is cloud-based. For example, user profiles can be stored in the cloud and/or Emoji processing may take place in the cloud.

In the embodiment shown in FIG. 2, the elements thereof are interconnected by a bus(es)/network(s) 201. However, in other embodiments, other types of connections can also be used. Moreover, in an embodiment, at least one of the elements of system 200 is processor-based. Further, while one or more elements may be shown as separate elements, in other embodiments, these elements can be combined as one element. The converse is also applicable, where while one or more elements may be part of another element, in other embodiments, the one or more elements may be implemented as standalone elements. These and other variations of the elements of system 200 are readily determined by one of ordinary skill in the art, given the teachings of the present principles provided herein, while maintaining the spirit of the present principles.

FIG. 3 shows an exemplary method 300 for Emoji semantic verification and recovery, in accordance with an embodiment of the present principles.

At step 305, receive an input string from a first user. In an embodiment, the string is received via the Emoji Editor Control Panel (EECP) 210. In another embodiment, the input string can be received via a browser or other application for verification and recovery in accordance with the present principles. The EECP 210, the browser, and the other application can be considered to include and/or otherwise involve a user interface. The input string can be all Emoji or an Emoji mixed sentence (e.g., part Emoji and part textural) or a textural sentence. It is to be appreciated that the input string can be textural, symbolic, pictographic, or icon based. That is, the input string can include any symbology including, but not limited to, textural characters, symbols, pictures, icons, Emoji, and so forth. Moreover, it is to be appreciated that the input string can be in any language including more than one language. For illustrative purposes, in the embodiment of FIG. 3, the input string is an Emoji mixed sentence having part textural content and part Emoji content.

At step 310, determine an Emoji preference for the input string. In an embodiment, the Emoji preference is determined via the Emoji Preference Profile (EPP) 260. In an embodiment, the EPP 260 is user based (e.g., different profiles for different users). In other embodiments, the EPP 260 can be entity based (same profile for all members of the entity, or different profiles based on position in entity, etc.), and so forth. Thus, in an embodiment, the EPP can include more than one profile, and step 310 can involve selecting the appropriate profile (e.g., for a particular user, a member of an entity, etc.).

At step 315, determine the Emoji preference for the input string from among the following options” (option 1) enable the Emoji verification feature; (option 2) disable the Emoji verification feature; (option 3) automatically convert a plain textural string to an Emoji mixed string; and (option 4) automatically interpret (convert) an Emoji mixed string to a plain textural string.

For option 1, the method proceeds to step 320. For option 2, the method proceeds to step 330. For option 3, the method proceeds to step 335. For option 4, the method proceeds to step 345.

Option 1—Enable Emoji verification feature

Option 1 presumes that the input string is either a pure Emoji string or an Emoji mixed string (mixed textual elements (e.g., characters, words, phrases, etc.) and Emoji characters).

At step 320, perform Emoji verification. In an embodiment, step 320 includes steps 320A-320F.

At step 320A, segment the input string to separate the textural elements from the Emoji in the input string. In an embodiment, the input string is segmented by the Emoji Segmentation Agent (ESA) 220. In an embodiment, the input string is segmented by consulting one or more dictionaries of the Emoji Dictionary (ED) 240.

At step 320B, interpret (convert) Emoji in the input string to normal plain text, by the Bidirectional Emoji-Text Interpreter (BETI) 250. The interpreting (converting) is performed in order to use the normal plain text for verification of the meaning of the Emoji in the input string. In an embodiment, the Emoji in the input string is interpreted (converted) by consulting one or more dictionaries of the Emoji Dictionary (ED) 240.

At step 320C, determine the semantic meaning of the input string or segmented portions thereof. In an embodiment, step 320C is performed by the Emoji Semantic Analyzer (ESAZ) 230. Preferably, the entire input string is evaluated semantically in order to fully consider context.

At step 320D, evaluate the input phrase with respect to the set of Preference Emoji Verification Rules (PEVRs) 260A (corresponding to the Emoji preference profile implicated by step 310) to confirm a meaning and applicability (i.e., the Emoji means what the user intends) of the Emoji in the input string or suggest another Emoji in place thereof, and output the original input string or a modified input string depending upon the evaluation.

At step 320E, determine whether or not to commit the Emoji (either as originally input in the input string or any suggested Emoji as specified in the modified input string, from step 320D). If so, then the method proceeds to step 330. Otherwise, the method returns to step 320B. In other embodiments, the method can return to step 320C or 320A to redo those steps, depending upon the implementation and settings.

At step 320F, commit the Emoji. In an embodiment, step 320F can involve un-altering (leaving as is) the original message or other container that included the input string or replacing the input string therein with the modified input string.

At step 325, forward the string output from step 320D (i.e., the original input string or the modified input string) to one or more intended recipients. Step 325 can involve forwarding the original message or other container that included in the input string, with either the original (verified) input string or the modified input string.

Option 2—Disable Emoji Verification Feature

Option 2 presumes that the input string is a plain textural string (i.e., no Emoji characters).

At step 330, forward the original input string to one or more intended recipients.

Option 3—Automatically Convert a Plain Textural String to an Emoji Mixed String

Option 3 presumes that the input string is a plain textural sentence (i.e., no Emoji characters).

At step 335, automatically convert a plain textural string to an Emoji mixed string. In an embodiment, step 335 includes steps 335A-335E.

At step 335A, interpret (convert) textural elements in the input string to Emoji characters, by the Bidirectional Emoji-Text Interpreter (BETI) 250. In an embodiment, the Emoji in the input string is interpreted (converted) by consulting one or more dictionaries of the Emoji Dictionary (ED) 240.

At step 335B, determine the semantic meaning of the input string. In an embodiment, step 335B is performed by the Emoji Semantic Analyzer (ESAZ) 230. The ESAZ 230 evaluates the semantics of the input string to ensure that the resultant Emoji characters generated in placed thereof are semantically correct. Preferably, the entire input string is evaluated semantically in order to fully consider context.

At step 335C, evaluate the input string with respect to the set of Preference Emoji Verification Rules (PEVRs) 260A (corresponding to the Emoji preference profile implicated by step 310) to confirm a meaning and applicability (i.e., the Emoji means what the user intends) of the Emoji with respect to the textural elements in the input string and suggest Emoji in place thereof, and output a modified input string including the suggested Emoji.

At step 335D, determine whether or not to commit the Emoji (in the modified input string, from step 335C). If so, then the method proceeds to step 330. Otherwise, the method returns to step 320A. In other embodiments, the method can return to step 320B or 320A to redo those steps, depending upon the implementation and settings.

At step 335E, commit the Emoji. In an embodiment, step 335E can involve un-altering (leaving as is) the original message or other container that included the input string or replacing the input string therein with the modified input string.

At step 340, forward the modified input string that is output from step 335C to one or more intended recipients. Step 340 can involve forwarding the original message or other container that included in the input string, with the modified input string containing one or more textural elements and one or more Emoji characters.

Option 4—Convert an Emoji Mixed String to a Plain Textural String

Option 4 presumes that the input string is an Emoji mixed string.

At step 345, automatically convert an Emoji mixed string to a plain textural string. In an embodiment, step 345 includes steps 345A-345F.

At step 345A, segment the input string to separate the textural elements from the Emoji in the input string. In an embodiment, the input string is segmented by the Emoji Segmentation Agent (ESA) 220. In an embodiment, the input string is segmented by consulting one or more dictionaries of the Emoji Dictionary (ED) 240.

At step 345B, interpret (convert) Emoji characters in the input string to textural elements, by the Bidirectional Emoji-Text Interpreter (BETI) 250. In an embodiment, the Emoji in the input string is interpreted (converted) by consulting one or more dictionaries of the Emoji Dictionary (ED) 240.

At step 345C, determine the semantic meaning of the input string or segmented portions thereof. In an embodiment, step 345C is performed by the Emoji Semantic Analyzer (ESAZ) 230. The ESAZ 230 evaluates the semantics of Emoji characters in the input string to ensure that the resultant textural elements generated in placed thereof are semantically correct. Preferably, the entire input string is evaluated semantically in order to fully consider context.

At step 345D, evaluate the input string with respect to the set of Preference Emoji Verification Rules (PEVRs) 260A (corresponding to the Emoji preference profile implicated by step 310) to confirm a meaning and applicability (i.e., the Emoji means what the user intends) of the Emoji in the input string and suggest textural elements in place thereof, and output a modified input string including the suggested Emoji.

At step 345E, determine whether or not to commit the textural elements (in the modified input string, output from step 345D). If so, then the method proceeds to step 330. Otherwise, the method returns to step 345B. In other embodiments, the method can return to step 345C or 345A to redo those steps, depending upon the implementation and settings.

At step 345F, commit the textural elements. In an embodiment, step 335F can involve replacing the input string therein with the modified input string (output from step 345D).

At step 350, forward the modified input string that is output from step 335C to one or more intended recipients. Step 350 can involve forwarding the original message or other container that included in the input string, with the modified input string containing textural elements.

A description will now be given of three exemplary input strings and suggested replacements therefor corresponding to three exemplary scenarios, in accordance with various embodiments of the present principles. The suggested replacements are provided in accordance with the present principles are described herein. In the examples, actual Emoji characters are not shown. Rather, the Emoji characters are denoted by brackets that include the text “Emoji character for” followed by a noun indicating the subject of the Emoji. Thus, “{Emoji character for a cactus}” is intended to denote the actual Emoji character for a cactus.

In the first scenario, an originally input Emoji mixed string is as follows:

“Want to eat {Emoji character for a cactus}?”

In the first scenario, corresponding to a mealtime, the suggested replacement is an output Emoji mixed string as follows:

“Want to eat {Emoji character for a taco}?”

Thus, regarding the first scenario, the present principles help the user to verify the meaning of the Emoji character for a CACTUS, and then suggest replacing it with a better Emoji character for a TACO.

In the second scenario, corresponding to a job application, an originally input Emoji string is as follows:

{Emoji character for a thumbs up sign}.

In the second scenario, one suggested replacement is an output textural string in English as follows:

approved.

In the second scenario, another suggested replacement can be an output textural string in another language such as Japanese, Spanish, and so forth.

Thus, regarding the second scenario, the present principles help the user to interpret (convert) an Emoji string to a textural string in English or any other language (in this example, Spanish).

In the third scenario, corresponding to a mealtime, an originally input plain textural string is as follows:

“Want to eat Mexican food?”

In the third scenario, the suggested replacement is an output Emoji mixed string as follows:

“Want to eat {Emoji for a taco}?

Thus, regarding the third scenario, the present principles help the user to interpret (convert) a plain textural string to an Emoji mixed string having the textural characters “Want to eat” and the Emoji character: {Emoji character for a taco}.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load balancing between clouds).

A cloud computing environment is service oriented with a focus on statelessness, low coupling, modularity, and semantic interoperability. At the heart of cloud computing is an infrastructure comprising a network of interconnected nodes.

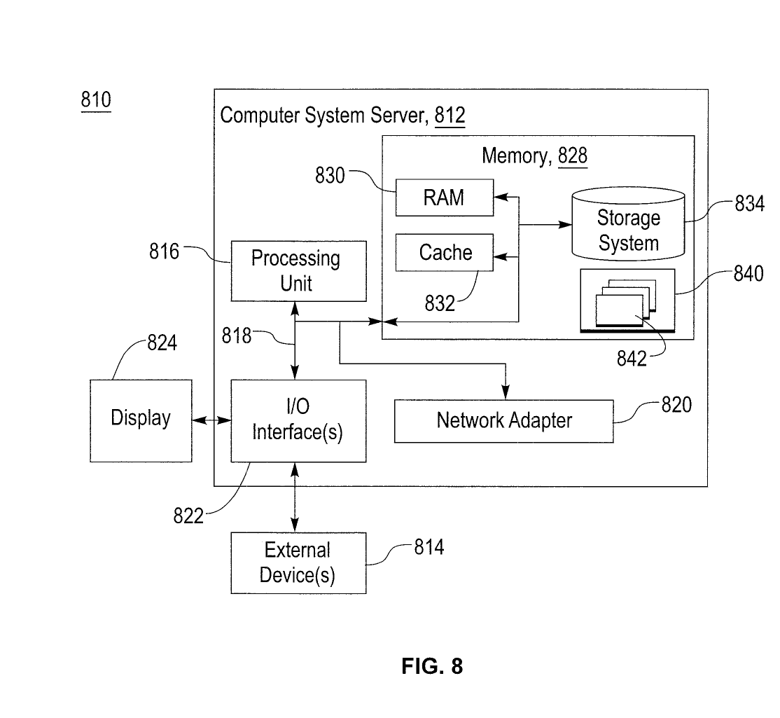

Referring now to FIG. 8, a schematic of an example of a cloud computing node 810 is shown. Cloud computing node 810 is only one example of a suitable cloud computing node and is not intended to suggest any limitation as to the scope of use or functionality of embodiments of the invention described herein. Regardless, cloud computing node 810 is capable of being implemented and/or performing any of the functionality set forth hereinabove.

In cloud computing node 810 there is a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 812 may be described in the general context of computer system executable instructions, such as program modules, being executed by a computer system. Generally, program modules may include routines, programs, objects, components, logic, data structures, and so on that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in cloud computing node 810 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 812 typically includes a variety of computer system readable media. Such media may be any available media that is accessible by computer system/server 812, and it includes both volatile and non-volatile media, removable and non-removable media.

System memory 828 can include computer system readable media in the form of volatile memory, such as random access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions of embodiments of the invention.

Program/utility 840, having a set (at least one) of program modules 842, may be stored in memory 828 by way of example, and not limitation, as well as an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the invention as described herein.

Computer system/server 812 may also communicate with one or more external devices 814 such as a keyboard, a pointing device, a display 824, etc.; one or more devices that enable a user to interact with computer system/server 812; and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to: microcode, device drivers, redundant processing units, external disk drive arrays, RAID systems, tape drives, and data archival storage systems, etc.

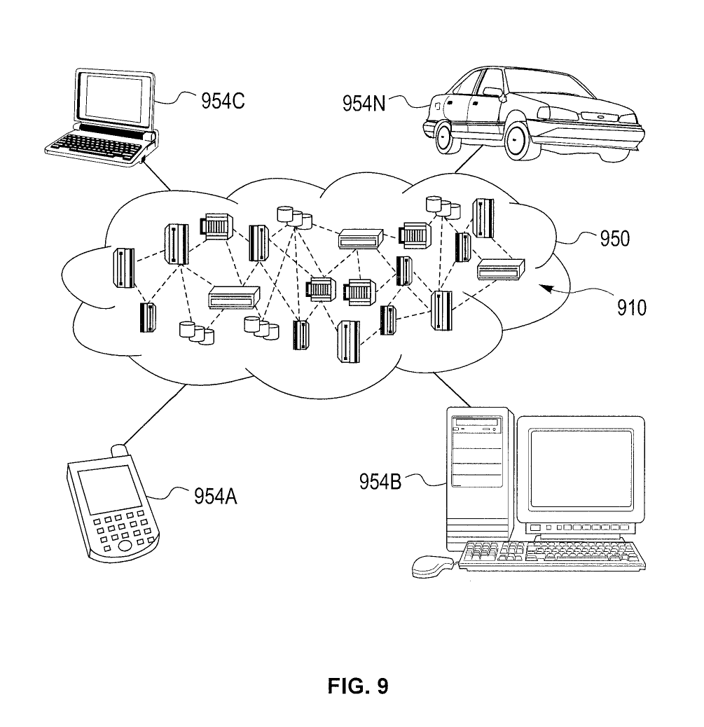

Referring now to FIG. 9, illustrative cloud computing environment 950 is depicted. As shown, cloud computing environment 950 comprises one or more cloud computing nodes 910 with which local computing devices used by cloud consumers, such as, for example, personal digital assistant (PDA) or cellular telephone 954A, desktop computer 954B, laptop computer 954C, and/or automobile computer system 954N may communicate. Nodes 910 may communicate with one another. They may be grouped (not shown) physically or virtually, in one or more networks, such as Private, Community, Public, or Hybrid clouds as described hereinabove, or a combination thereof. This allows cloud computing environment 950 to offer infrastructure, platforms and/or software as services for which a cloud consumer does not need to maintain resources on a local computing device. It is understood that the types of computing devices 954A-N shown in FIG. 9 are intended to be illustrative only and that computing nodes 910 and cloud computing environment 950 can communicate with any type of computerized device over any type of network and/or network addressable connection (e.g., using a web browser).

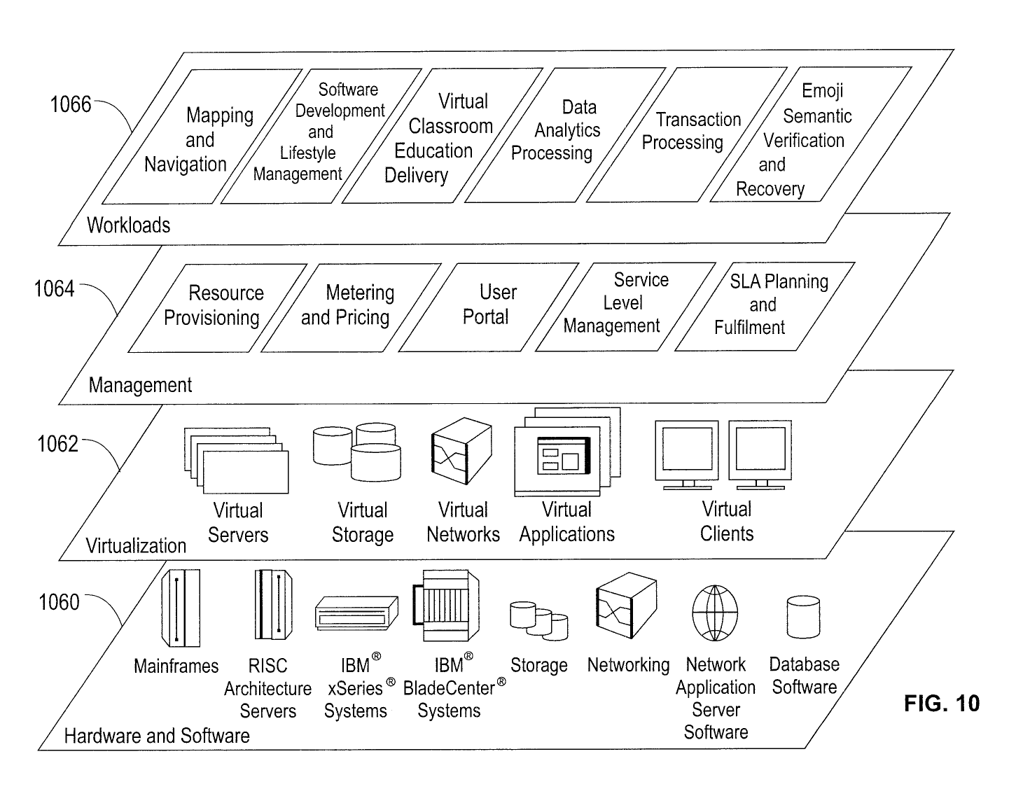

Referring now to FIG. 10, a set of functional abstraction layers provided by cloud computing environment 950 (FIG. 9) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 1060 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 1062 provides an abstraction layer from which the following examples of virtual entities may be provided: virtual servers; virtual storage; virtual networks, including virtual private networks; virtual applications and operating systems; and virtual clients.

In one example, management layer 1064 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 1066 provides examples of functionality for which the cloud computing environment may be utilized. Examples of workloads and functions which may be provided from this layer include: mapping and navigation; software development and lifecycle management; virtual classroom education delivery; data analytics processing; transaction processing; and Emoji semantic verification and recovery.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present principles, as well as other variations thereof, means that a particular feature, structure, characteristic, and so forth described in connection with the embodiment is included in at least one embodiment of the present principles. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1-13. (canceled)

14. A computer program product for assisting a user with Emoji in communication content, the computer program product comprising a non-transitory computer readable storage medium having program instructions embodied therewith, the program instructions executable by a computer to cause the computer to perform a method comprising:
receiving, by a user interface, an input string that includes one or more Emoji characters for interpretation based on a user profile; and
verifying and recovering, by a processor-based Emoji semantic verification and recovery system, an intended meaning of the one or more Emoji characters in the input string, by applying rules based on the user profile and natural language processing to analyze the input string for semantic context, interpret the one or more Emoji characters based on the semantic context, and replace at least one of the one or more Emoji characters with one or more other characters to form a modified input string.

15. The computer program product of claim 14, wherein the one or more Emoji characters are semantically interpreted using at least two different languages.

16. The computer program product of claim 14, further comprising suggesting the one or more other characters to the user for use in forming the modified input string therefrom.

17. The computer program product of claim 16, wherein the one or more other characters comprise one or more other Emoji characters.

18. A system for assisting a user with Emoji in communication content, the system comprising:
a user interface for receiving an input string that includes one or more Emoji characters for interpretation based on a user profile; and
a processor-based Emoji semantic verification and recovery system for verifying and recovering an intended meaning of the one or more Emoji characters in the input string, by applying rules based on the user profile and natural language processing to analyze the input string for semantic context, interpret the one or more Emoji characters based on the semantic context, and replace at least one of the one or more Emoji characters with one or more other characters to form a modified input string.

19. The system of claim 18, wherein the one or more other characters in the modified input string are in a different language than the input string

20. The system of claim 18, wherein the one or more Emoji characters are semantically interpreted using at least two different languages.
